(19) United States
(12) Patent Application Publication
(10) Pub. No.: US 2010/0303156 A1
(43) Pub. Date: Dec. 2, 2010

(54) Method and Apparatus for Providing Precise Transport Stream Packet Ordering and Erasure Optimization for Digital Video Decoder

(75) Inventors: Feng Huang, Hoffman Estates, IL (US); Tianhao Li, Chicago, IL (US); Yihong Qi, Sunnyvale, CA (US); Yan Li, Newtown, PA (US); Azzedine Touzni, Algonquin, IL (US)

Correspondence Address: ADVANCED MICRO DEVICES, INC.;C/O VEDDER PRICE P.C., 222 N.LASALLE STREET, CHICAGO, IL, 60601, US

(73) Assignee: ADVANCED MICRO DEVICES, INC., Sunnyvale, CA (US)

(21) Appl. No.: 12/475,202

(22) Filed: May 29, 2009

(51) Int. Cl. H04N 11/02

(52) U.S. Cl. 375/240.25; 375/E07.027

(57) ABSTRACT

One method includes estimating, by a lost packet determination logic, an expected number of packets, expected to be received within a time interval, based on packet arrival speed; and determining a number of lost packets by using the expected number of packets and a packet counter wherein the packet counter counts a plurality of received packets. The method may further include comparing the expected number of packets to the packet counter and determining that the expected number of packets is greater than the packet counter; and then using the expected number of packets and the packet counter to determine the actual number of lost packets, where the actual number of lost packets exceeds the packet counter maximum. The methods may also introduce erasures when there is uncertainty of whether some packets or bytes are in error, such that a simplified erasure-based Reed-Solomon decoder may be used.

### FIELD OF THE DISCLOSURE

The present disclosure is related to decoding encapsulated data and transport layer data and methods and apparatuses that facilitate correct decoding of received transport layer packets.

### BACKGROUND

Real time video transmissions, such as provided by Digital Video Broadcasting (DVB) systems, cannot accommodate automatic repeat request (ARQ) mechanisms since the time required for data retransmission would unacceptably slow down and interrupt the flow of video data to the receiver. Therefore as some data will inevitably be lost due to various factors caused by the mobile environment, such as radio propagation delay and fading, video systems rely on error correction to maintain an acceptable level of quality with respect to the video stream.

For DVB systems such as DVB-H/SH, an “MFEC” (Multi-protocol Encapsulation Forward Error Correction) (also “MPE-FEC”) module was introduced to improve error correction capability in high mobility environments and also to save power. The Reed-Solomon (RS) (255, 191) code is used for error correction in an MFEC table and an erasure based RS (ERS) decoder or even a simplified ERS may be used in decoding. An MPEG Transport Stream Processor (MTSP) is used to create the MFEC table and generate corresponding erasure information for the ERS decoder in the next step. The most challenging task in designing the MTSP block is how to place all data into correct positions and provide erasure information accurately.

One approach is to only use the transport stream packet counter, that is, the Continuous Counter, to track lost transport stream (TS) packets. However this approach cannot handle the case of more than 16 lost packets. Another approach is to use the time information inside the MPE (Multi-protocol Encapsulation) section header to track IP packets. However this approach only performs well on fixed length IP packets and most streams utilize IP packets with variable length.

Other approaches only implement a simplified ERS decoder without erasure optimization in the decoding MFEC table. Approaches that implement a fully functioning ERS, however, decrease the throughput and cost more chip area. Decreasing system throughput is a more serious problem than costing more chip area, since most MFEC tables contain more than 512 rows, which means that the decoder is called 512 times for one table.

Therefore a need exists for methods and apparatuses that provide accurate Transport Stream (TS) packet tracking and that may also optimize the erasure information for different ERS decoders.

### BRIEF DESCRIPTION OF THE DRAWINGS

FIG. 1 is a diagram of a protocol stack used for DVB such as within DVB-H and DVB-SH receivers.

FIG. 2 is a block bit map diagram of an MFEC table as used in DVB systems.

FIG. 3 is a block bit map diagram of an MFEC data map, IP datagrams and Transport Stream packets as used in DVB systems.

FIG. 4 is a flow chart illustrating an operation for determining a number of lost Transport Stream (TS) packets in accordance with an embodiment.

FIG. 5 is a flow chart illustrating further details of the operation illustrated in FIG. 4.

FIG. 6 is a flow chart illustrating an operation for introducing erasures in accordance with an embodiment.

FIG. 7 is a flow chart illustrating another operation for introducing erasures in accordance with an embodiment.

FIG. 8 is a flow chart illustrating further details of the operation illustrated in FIG. 7.

FIG. 9 is a block diagram of a DVB-H/SH receiving apparatus in accordance with the embodiments.

FIG. 10 is a block diagram of a DVB-H/SH receiving apparatus in accordance with an embodiment that uses a simplified erasure based Reed-Solomon decoder.

The present disclosure provides an accurate Transport Stream (TS) packet tracking method and apparatus that tracks TS packets based on estimating the TS packet arriving speed and the Continuous Counter (CC) inside TS packet header. The present disclosure also provides a method and apparatus for optimizing erasure information for different ERS decoders including a simplified ERS decoder.

One method disclosed herein includes estimating, by a lost packet determination logic, an expected number of packets, expected to be received within a time interval, based on packet arrival speed; and determining a number of lost packets using the expected number of packets and the packet counter wherein the packet counter counts a plurality of received packets. The method may determine the number of lost packets by comparing the expected number of packets to the packet counter and determining that the expected number of packets is greater than the packet counter; and then use the expected number of packets and the packet counter to determine the actual number of lost packets, where the actual number of lost packets exceeds a packet counter maximum of the packet counter. For example, the transport stream packet counter in DVB systems only accounts for sixteen packets.

Another method disclosed herein includes receiving a plurality of transport steam packets that encapsulate at least one multi-protocol encapsulation (MPE) packet including an MPE packet header, where the MPE packet further encapsulates a plurality of Internet Protocol (IP) datagrams. The MPE packet is received in an MPE frame that includes forward error correction (FEC) data for the MPE packet. The method then decodes the plurality of transport stream packets and, if it obtains a decoding failure, marks all bytes of the MPE packet including the MPE packet header as erasures, to take advantage of the large number of erasures that can be handled by the erasure-based Reed-Solomon decoder, and introduces the erasures to the ERS along with a plurality of successfully decoded MPE packets. The method may also introduce the erasures for decoding by a simplified erasure-based Reed-Solomon (ERS) decoder logic that includes only a Syndrome Calculation Unit and an Error Correlation Unit, but does not include a Key Equation Solver and a Chien Search Unit.

Another method includes receiving a portion of an MPE-FEC table, via a plurality of transport steam packets; determining that an error is possible in the MPE-FEC table; designating an area of the MPE-FEC table as an area of suspicion and marking all bytes in the area of suspicion as erasures. The method then introduces the erasures to a simplified ERS decoder logic and decodes the erasures along with a remainder of the MPE-FEC table. Determining that an error is possible in the MPE-FEC table may include detecting a conflict between a parity counter and a packet counter.

The present disclosure also provides an apparatus comprising a multi-protocol encapsulation forward error correction (MFEC) logic; a lost packet determination logic, operatively coupled to said MFEC logic, and operative to estimate an expected number of packets, expected to be received within a time interval, based on packet arrival speed; and determine a number of lost packets using the expected number of packets and a packet counter wherein the packet counter counts a plurality of received packets. The lost packet determination logic may also be operative to compare the expected number of packets to the packet counter (such as the transport stream Continuous Counter) and determine that the expected number of packets is greater than the packet counter; and determine the actual number of lost packets by the expected number of packets and the packet counter, where the actual number of lost packets exceeds the packet counter maximum, which is sixteen packets in the case of the TS Continuous Counter.

The lost packet determination logic may be further operative to determine the correct order of a plurality of received packets prior to providing the received packets to a decoder logic. A DVB receiver may include the above described logic.

The present disclosure further provides a computer readable memory, that includes executable instructions for execution by at least one processor, that when executed cause the at least one processor to perform the above described operations. The computer readable memory may be any suitable non-volatile memory such as, but not limited to programmable chips such as EEPROMS, flash ROM (thumb drives), compact discs (CDs) digital video disks (DVDs), etc., that may be used to load executable instructions or program code to other electronic devices such as those described in further detail herein below.

The various embodiments disclosed herein may be used in a variety of devices, such as, but not limited to, mobile handsets, DVB receivers (such as, but not limited to, set top boxes, DTV, etc.), and may be used with various DVB systems including DVB-H. Receivers and devices employing the teachings disclosed herein may thus exhibit improved DVB reception over receivers and devices that do not make use of the various embodiments or equivalents thereof.

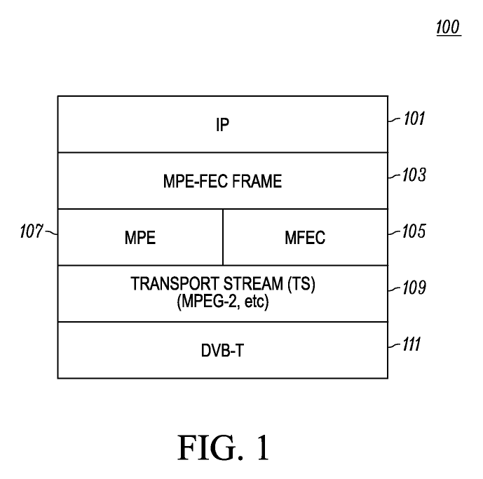

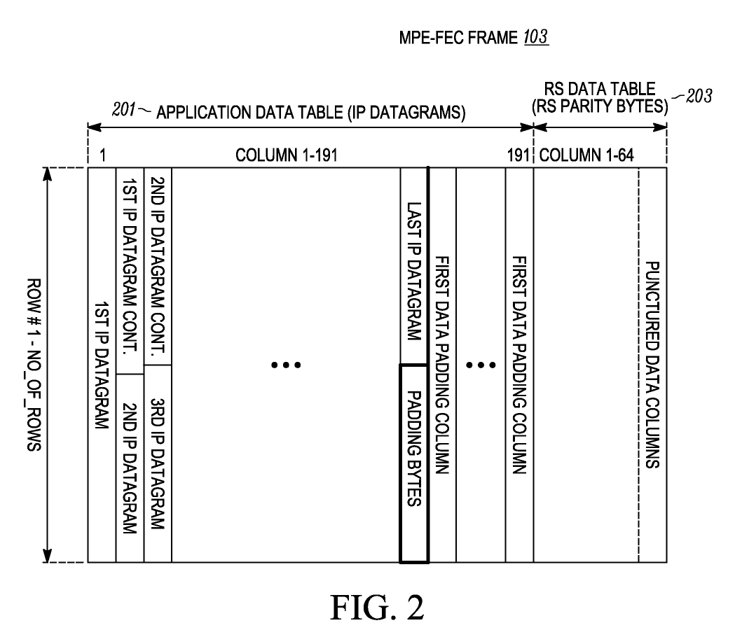

Turning now to the drawings wherein like numerals represent like components, FIG. 1 illustrates a protocol stack for DVB-H. The protocol stack includes a Multi-protocol encapsulation—Forward Error Correction (MPE-FEC) frame 103. For DVB-H, IP datagrams of the IP layer 101, are protected by Reed-Solomon (RS) parity data that is calculated for IP datagrams in a given burst. This RS parity data is then encapsulated in the MPE-FEC frame which is sent as part of the burst. The RS parity data is contained within its own section, the “MFEC” 105, while the application data is encapsulated in the MPE 107 section. The encapsulated IP datagrams and corresponding RS parity data are transported over the Transport Stream (TS) layer 109 and transmitted over the DVB-T radio interface layer 111. FIG. 2 provides further details of the MPE-FEC frame 103.

The IP datagrams are encapsulated in an Application Data Table 201 and the RS parity data are provided in an RS data table 203. The MPE-FEC frames 103, and a corresponding MFEC module on the DVB receiver side, are utilized in DVB-H/SH systems to combat the Doppler frequency shifts that can occur in a high mobility environment and also to save power. The power savings aspects may be achieved in various ways, however, such methods are not within the scope of the present disclosure and are therefore not discussed herein.

As shown in FIG. 2, the Application Data Table 201 is created column wise and is decoded row by row. Each row in the table 201 is protected by a ¾ code rated Reed-Solomon (255, 191) code. Other code rates could be obtained by using shorted or punctured codes of the RS (255, 191) code. Adding padding columns is one approach to shortening the RS code, however this approach also adds overhead for the RS data. This may be compensated for by puncturing RS columns as illustrated in FIG. 2, such that not all RS columns are transmitted. While this reduces the RS data overhead, it weakens the code. In any case, the RS correction code is a strong error correction code which can accommodate up to 32 errors or equivalently 64 erasures in every row if a standard RS (255, 191) code is used. The overall table of the MPE_FEC frame 103, which includes Application Data Table 201 and RS parity table 203, is herein referred to as the “MFEC table.”

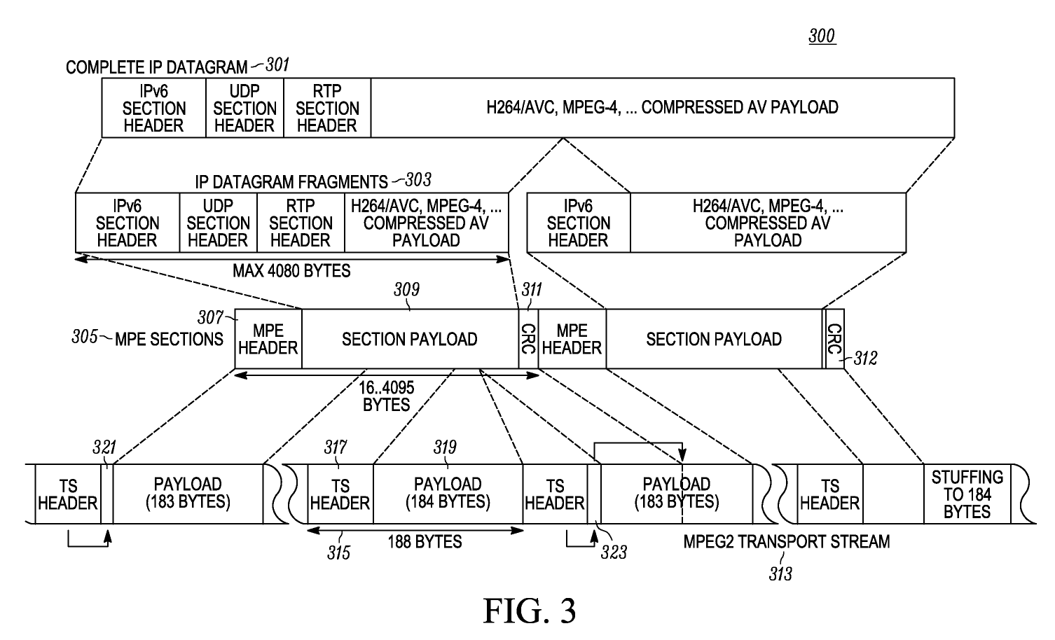

FIG. 3 provides further details of encapsulation and shows that the IP datagrams 301 are first encapsulated into MPE sections 305 prior to encapsulation into the transport stream 313. In the transport stream 313, the MPE sections 305 are then encapsulated into TS packets 315. The MPE data includes an MPE header 307 which further includes a section offset field. The section offset field provides the offset in the MFEC table for the encapsulated IP datagram and provides a section length field that indicates the length of that section. At the transport stream layer 313, the TS packet header 317 includes a “Continuous Counter” (CC) that is used at the receiver side to count lost TS packets. The TS packet header 317 may also provide one bit, such as 321 and 323, to indicate whether the payload bytes are at the beginning of the MPE section, such as MPE header 307. This bit may also indicate the offset location of the next payload packet start position. However, numerous approaches may be used for encapsulating the MPE/MFEC sections into the TS packets and any such approaches would remain in accordance with the embodiments. With respect to the CC, because the CC uses only 4 bits, it cannot count more than 16 lost packets. In other words, intervals may have more than 16 lost packets and in such cases the counter will not provide a correct indication of the actual number of packets lost. That is, if an interval of 16 or more lost packets occurs, the counter will begin again at zero such that, for example, a 17^{th} lost packet would appear as the first lost packet (i.e. the CC for the 18th packet would indicate 1 lost packet indicating that the 17th packet was lost) in the sequence. In other words the CC can only accommodate a maximum number of lost packets which is 15 lost packets. This creates a problem because any incorrect ordering of the packets will result in failure of the decoder.

Such large continuous TS packet losses, and loss of the corresponding MPE section headers, may occur with high probability when a receiver is operating in, for example, a poor radio coverage area. Because of the strength of the erasure based Reed-Solomon (ERS) decoding, it would not be that critical to the system if some correct bytes were marked as erasures for a simplified ERS decoder used in the DVB-H/SH system, since the simplified ERS decoder is indeed sufficiently strong enough to handle the bytes correctly. Conversely however, the simplified ERS decoder will converge to an error codeword even if only a single error byte is erroneously marked as correct byte.

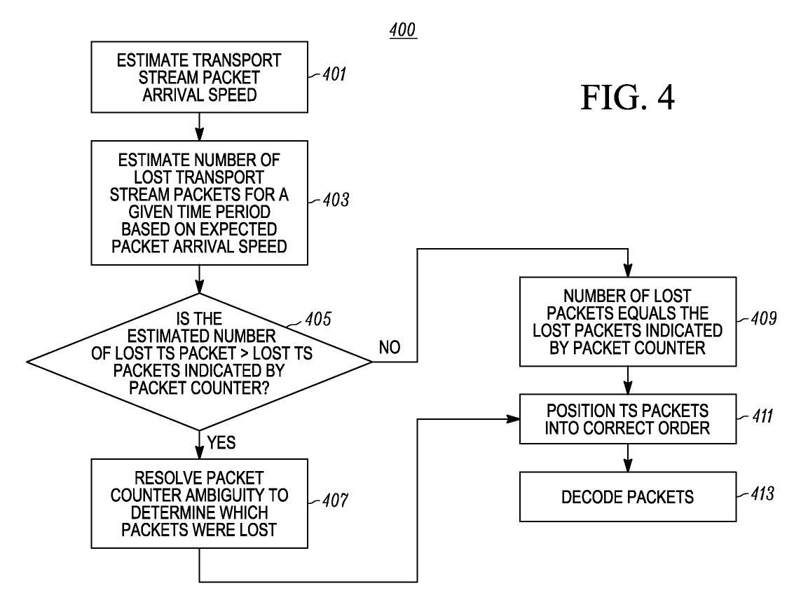

Therefore, two major approaches are described herein to improve the performance of the ERS decoder, including the simplified ERS decoder, used in DVB-H/SH systems. FIG. 4 is a flow chart 400 of a method in accordance with the embodiments for determining a number of lost TS packets. In 400, the number of lost packets may be determined by estimating the arrival speed of TS packets. Based on the measurable time gap between two sequentially received TS packets, along with the estimated speed of TS packets, a rough number of lost packets between these two TS packets may be calculated. This rough number of lost TS packets, along with the CC inside the TS packet header, may be used to determine the accurate number of lost TS packets, even for cases where more than 16 packets were lost during the time gap period.

Beginning in 401, the TS packet arrival speed is estimated. Then, in 403, and, for example, for two sequentially received TS packets that were received over a time period, the number of lost TS packets is estimated for the time period based on the expected TS packet arrival speed estimated in 401. In 405, if the number of estimated lost TS packets is not greater than the number of lost TS packets indicated by the TS packet counter, for example by the CC counter, then the number of lost TS packets is equal to the number of lost TS packets indicated by the TS packet counter as shown in 409. The TS packets may be placed into the correct order as shown in 411 and decoded as shown in 413.

However, if in 405 the estimated number of lost packets is greater than the number of lost packets indicated by the packet counter, the packet counter ambiguity is resolved in 407 to determine which, and/or how many, packets were lost. The received packets may then be placed into the correct order in 411 and decoded as shown in 413.

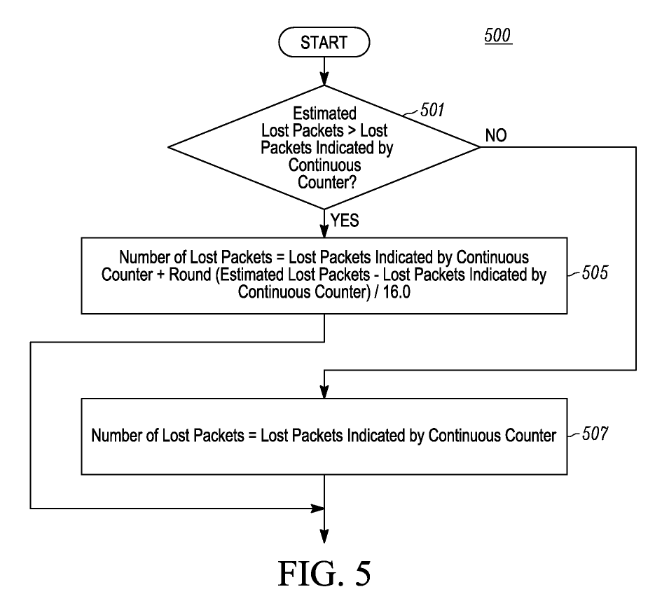

FIG. 5 provides further details of the calculation of the final number of lost packets. The variables indicated in the flowchart 500 of FIG. 5 are pseudo code variables and are self explanatory with respect to the variable names. In 501 if the number of expected packets based on packet arrival speed is “Estimated Lost Packets” and this is greater than the Continuous Counter(CC) indicated lost packets, then an ambiguity must be resolved in 505. The number of packets counted by the CC is only 16 as was discussed previously. Therefore, cases where 16 or more continuous packets are lost must be corrected so that the packet order of the received packets can be correctly determined. Therefore in 505 the difference between “Estimated Lost Packets” and “Lost Packets Indicated by Continuous Counter” is calculated. Then the additional lost packets (over 16) is calculated by rounding of the difference and dividing by 16 as shown in 505. Otherwise, the number of lost packets is equal to the lost packets indicated by the CC as shown in 507.

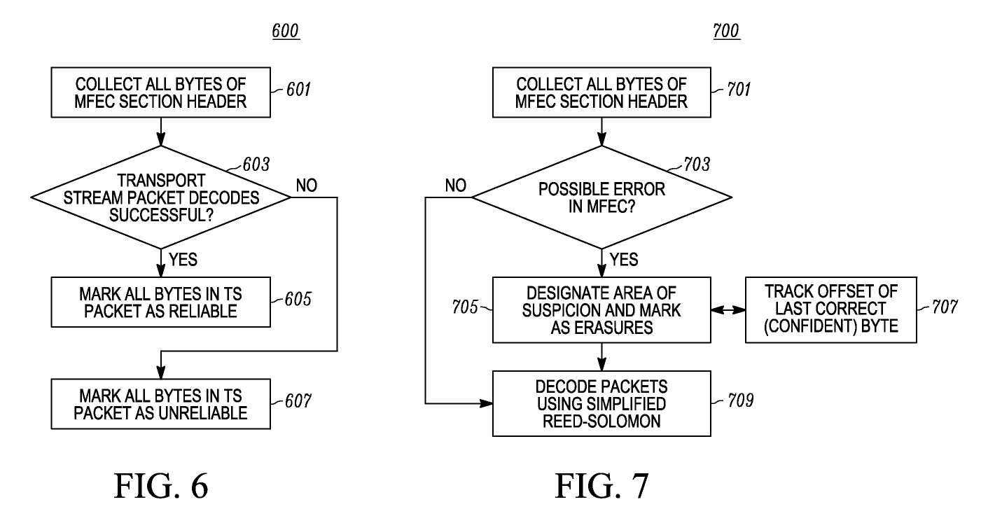

Another approach provided herein for improving ERS decoding in the various embodiments is to reduce the possibility of ordering or other errors by introducing packet erasures into areas of the MFEC table that may be considered suspicious, and take advantage of the large number of erasures that can be handled by the ERS decoder. FIG. 6 provides a flow chart 600 illustrating high level operation of introduction of erasures in accordance with an embodiment using a simplified ERS decoder. In 601, all bytes of the MFEC section header are collected by a receiver. If the TS packets are successfully decoded in 603, then all bytes of the TS packet may be marked as reliable as shown in 605. Otherwise, all bytes in the TS packet may be marked as unreliable as shown in 607. It is to be understood that the decoding check performed in 603 may be ERS decoding, but may also be a Cyclic Redundancy Check (CRC) as is used in DVB-SH systems.

As discussed previously, an erasure based Reed-Solomon (ERS) decoder is used in decoding the MFEC table. It is well known that the ERS decoder is composed of a Syndrome Calculation Unit (SCU), Key Equation Solver (KES), Chien Search Unit (CSU) and an Error Correlation Unit (ECU). The KES is the most difficult part to implement and the CSU is the most time consuming unit in terms of processing time. However if erasure positions can be accurately pointed out, a simplified ERS decoder consisting of only an SCU and an ECU can be utilized to save chip area and increase the throughput of the system. This is possible in DVB-H/SH systems since the detection error ratio (the miss ratio, the ratio of an error packet declared as an errorless packet and the false alarm ratio, the ratio of an errorless packet declared as an error packet) of the RS decoder in DVB-H or the CRC error checker in DVB-SH is almost zero. The remaining issue is how to write all data along with corresponding erasure information into the correct position in MFEC table.

Since any false marking of error bytes as correct bytes will generate a severe problem for the simplified ERS decoder, in situations where it may be determined for certain that there is something wrong in writing the MFEC table, in the various embodiments, the entire smallest suspicious area may be marked as erasures. To find the smallest suspicious area, a receiver may track the offset of the last byte of the MFEC table that the receiver can be confident is reliable. Reliable means that on each row of the frame the correct byte positions are exactly known whereas any missing byte positions are unreliable.

FIG. 7 illustrates this at a high level of operation. In 701, all bytes of the MFEC section header are collected. If the MFEC contains a possible error in 703, an area of suspicion may be designated and marked as erasures as in 705. The offset of the last correct, or confident, byte is tracked in 707 for designating the area of suspicion. The remaining packets may be decoded using the simplified ERS as shown in 709. Also, if no errors are present in the MFEC in 703 the ERS can decode the packets in 709.

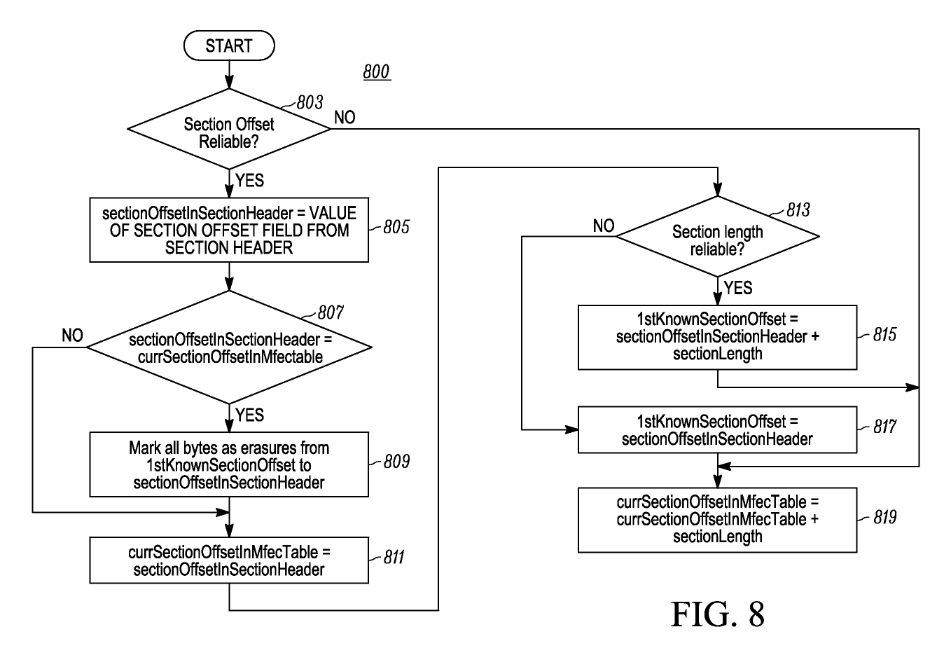

FIG. 8 depicts the flow to track the last known offset in MFEC table and mark erasures if needed. This operation is called when all bytes of the section header are collected. In FIG. 8, the byte reliable information comes from a TS “packet reliable” flag. If the TS packet can be decoded successfully in DVB-H, or pass the CRC checking used in DVB-SH, all bytes in this TS packet are marked as reliable. Conversely, if decoding fails all bytes in the TS packet are marked as unreliable. If one field in the section header occupies more than one byte, this field is marked as reliable only if all those bytes occupied are reliable.

The variables indicated in the flowchart 800 of FIG. 8 are pseudo code variables and are self explanatory with respect to the MFEC table definitions. Thus in 800, if the section offset is reliable in 803, the variable “sectionOffsetInSectionHeader” is equal to the value of the section offset field from the section header as shown in 805. If the section offset in 803 is unreliable, then the operation moves to 819 where the variable “currSectionOffsetInMfecTable” is equal to “currSectionOffsetInMfecTable” plus the “sectionLength.” From 805 the operation proceeds to 807 where a check is performed of whether the “sectionOffsetInSectionHeader” equals the “currSectoinOffsetInMfecTable.” If yes, then all bytes from the “1stKnownSectionOffset” to the “sectionOffsetInSectionHeader” are marked as erasures in 809 and the procedure moves to 811. If no in 807, the procedure also moves to 811 where the “currSectionOffsetInMfecTable” equals “sectionOffsetInSectionHeader.” The procedure moves to 813 and checks if the section length is reliable. If yes, the “1stKnownSectionOffset” equals the “sectionOffsetInSectionHeader” plus the “sectionLength.” If no, then the “1stKnownSectionOffset” equals only the “sectionOffsetInSectionHeader” variable. The procedure is completed in 819 where the variable “currSectionOffsetInMfecTable” is equal to “currSectionOffsetInMfecTable” plus the “sectionLength.”

Simulation results have shown that the MFEC table error performance at 5% criteria will improve 50 Hz for streams with IP and burst size changing dynamically and consistently like most streams used in the real world. With the section tracking method as described above, the simplified ERS decoder could achieve similar performance to those using a fully implemented ERS decoder.

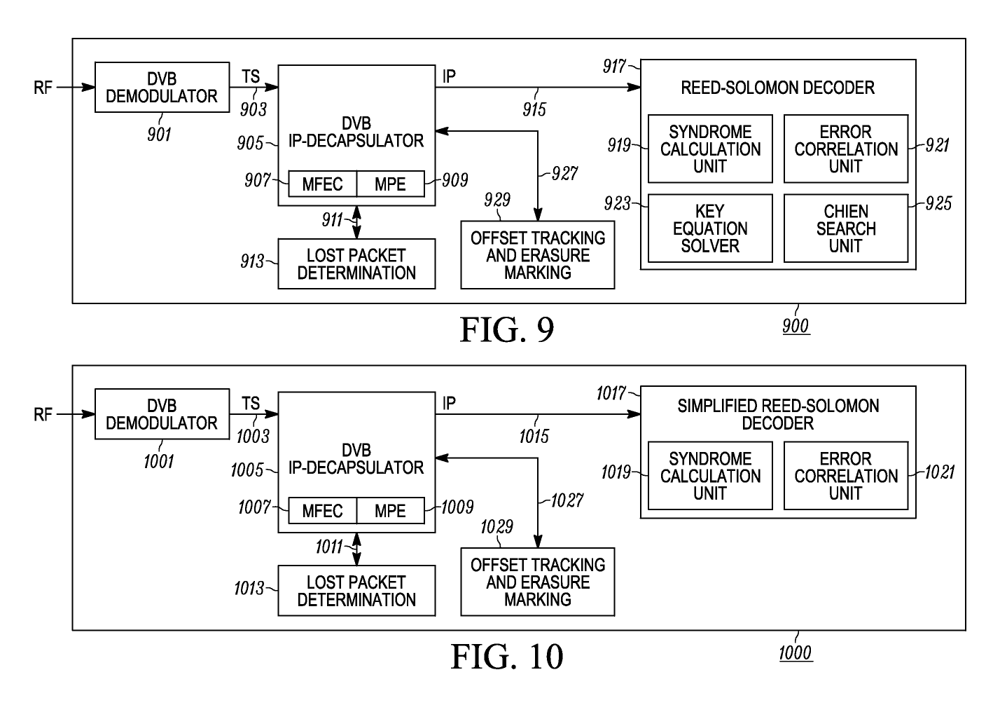

The operations of the various embodiments as described in the flowcharts may be implemented as, or using, various types of logic. The terms “logic” and/or “module” as used herein includes software and/or firmware executing on one or more programmable processors, ASICs, DSPs, hardwired logic or combinations thereof. Therefore, in accordance with the embodiments, the various logic and operations of the various flowcharts described herein, etc., may be implemented in any appropriate fashion as would be understood by one of ordinary skill and would remain in accordance with the embodiments herein disclosed. FIG. 9 and FIG. 10 are block diagrams of a DVB-H/SH receiving apparatus in accordance with the various embodiments and are illustrative examples of the logic required for implementing the various embodiments.

FIG. 10 is a block diagram of a DVB-H/SH receiving apparatus in accordance with an embodiment that uses a simplified erasure based Reed-Solomon decoder. It is to be understood that FIGS. 9 and 10, and the other figures provided in the present disclosure, are for illustrative purposes only. The purpose of the illustrations is to explain to one of ordinary skill in the art how to make and use the herein disclosed embodiments. Therefore the figures are limited to showing and describing the elements necessary to facilitate an understanding, by one of ordinary skill in the art, of how to make and use the described embodiments. Therefore the various figures, such as FIG. 9 and FIG. 10, are not intended to be complete schematic representations of all of the logic or all of the various components and devices illustrated, but, rather, are intended to illustrate the logic components of the various embodiments and the interrelation and connections of those logic components to other logic components of the device. Further therefore, various arrangements of internal components and corresponding connectivity may be utilized and such arrangements and corresponding connectivity would remain in accordance with the embodiments herein disclosed.

Turning to FIG. 9, a DVB receiver 900 is illustrated and includes a DVB demodulator logic 901 which receives a radio frequency (RF) DVB signal and demodulates it to obtain the transport stream (TS) 903. The TS 903 is provided to a DVB IP-Decapsulator logic 905 which includes the MFEC 907 logic and MPE 909 logic. The DVB IP-Decapsulator provides the IP stream 915 to the erasure based Reed-Solomon (ERS) decoder 917. The ERS decoder 917 is a full ERS decoder and includes a Syndrome Calculation Unit 919, an Error Correlation Unit 921, a Key Equation Solver 923 and a Chien Search Unit 925. In accordance with the embodiments, the receiver 900 also includes lost packet determination logic 913 and may also include offset tracking and erasure marking logic 929. The lost packet determination logic 913 implements operations such as that illustrated by FIG. 4 and FIG. 5. The offset tracking and erasure marking logic 929 implements logic such as that illustrated by FIGS. 6, 7 and 8. The lost packet determination logic 913 and offset tracking and erasure marking logic 929 are shown operatively coupled to the DVB IP-Decapsulator logic 905 via couplings 911 and 929, respectively. However in some embodiments, the lost packet determination logic 913 and offset tracking and erasure marking logic 929 may be included within, and integral to, said DVB IP-Decapsulator logic 905. Therefore, in accordance with the embodiments, the various logic illustrated in FIG. 9 is collectively referred to herein as packet decoding logic.

FIG. 10 illustrates a similar receiver 1000 to that of FIG. 9, receiver 900, except that the receiver 1000 only uses a simplified ERS 1007 which includes only a Syndrome Calculation Unit 1019 and an Error Correlation Unit 1021. This is possible because the lost packet determination logic 1013 and offset tracking and erasure marking logic 1029 provide accurate packet ordering and deletes, that is, marks as erasures, any suspicious packets that may have erroneously been marked as correct. The lost packet determination logic 1013 and offset tracking and erasure marking logic 1029 are shown operatively coupled to the DVB IP-Decapsulator logic 1005 via couplings 1011 and 1027, respectively. However in some embodiments, the lost packet determination logic 1013 and offset tracking and erasure marking logic 1029 may be included within, and integral to, said DVB IP-Decapsulator logic 1005. Therefore, in accordance with the embodiments, the various logic illustrated in FIG. 10 is collectively referred to herein as packet decoding logic.

Other variations that would be equivalent to the herein disclosed embodiments may occur to those of ordinary skill in the art and would remain in accordance with the spirit and scope of embodiments as defined herein by the following claims.

What is claimed is:

1. A method comprising:
estimating, by packet decoding logic, an expected number of packets, expected to be received within a time interval, based on packet arrival speed; and
determining a number of lost packets, by said packet decoding logic, using the expected number of packets and a packet counter wherein the packet counter counts a plurality of received packets.

2. The method of claim 1, wherein determining a number of lost packets, further comprises comparing, by said packet decoding logic, said expected number of packets to said packet counter and determining that said expected number of packets is greater than said packet counter; and
determining a number of lost packets, by said packet decoding logic, using said expected number of packets and said packet counter, where said number of lost packets exceeds a packet counter maximum of said packet counter.

3. The method of claim 1, further comprising:
determining, by said packet decoding logic, the correct order of a plurality of received packets prior to providing said received packets to a decoder logic.

4. The method of claim 3, wherein estimating, by packet decoding logic, an expected number of packets, expected to be received within a time interval, based on packet arrival speed, comprises:
estimating an expected number of transport stream packets forming an multi-protocol encapsulation forward error correction table; and
wherein determining, by said lost packet determination logic, the correct order of a plurality of received packets prior to providing said received packets to a decoder logic, comprises determining the correct order of said transport stream packets in said multi-protocol encapsulation forward error correction table.

5. A method comprising:
receiving a plurality of transport steam packets, said transport stream packets encapsulating at least one multi-protocol encapsulation (MPE) packet including an MPE packet header, said multi-protocol encapsulation packet further encapsulating a plurality of Internet Protocol (IP) datagrams, wherein said MPE packet is received in an MPE frame that includes forward error correction (FEC) data for said MPE packet;
decoding the plurality of transport stream packets by packet decoding logic and obtaining a decoding failure;
marking all bytes of said MPE packet including said MPE packet header as erasures; and
introducing said erasures to an erasure based decoder along with a plurality of successfully decoded MPE packets.

6. The method of claim 5, wherein introducing said erasures to an erasure based decoder along with a plurality of successfully decoded MPE packets, comprises:
introducing said erasures to an erasure based Reed-Solomon decoder along with a plurality of successfully decoded MPE packets.

7. The method of claim 6, wherein said erasure based Reed-Solomon decoder is a simplified erasure-based Reed-Solomon (ERS) decoder logic including a Syndrome Calculation Unit and an Error Correlation Unit, but not including a Key Equation Solver and a Chien Search Unit, further comprising:
decoding, using said simplified ERS decoder logic, said erasures and said plurality of successfully decoded MPE packets.

8. A method comprising:
receiving a portion of a multi-protocol encapsulation (MPE) forward error correction (FEC) MPE-FEC table, via a plurality of transport steam packets, said transport stream packets encapsulating at least one MPE packet including an MPE packet header, said MPE packet further encapsulating a plurality of Internet Protocol (IP) datagrams;
determining by packet decoding logic that an error is possible in the MPE-FEC table;
designating an area of said MPE-FEC table as an area of suspicion and marking all bytes in said area of suspicion as erasures;
introducing said erasures to a simplified erasure-based Reed-Solomon (ERS) decoder logic including a Syndrome Calculation Unit and an Error Correlation Unit, but not including a Key Equation Solver and a Chien Search Unit; and
decoding, using said simplified ERS decoder logic, said erasures along with a remainder of said MPE-FEC table.

9. The method of claim 8, wherein determining that an error is possible in the MPE-FEC table, comprises:
detecting a conflict between a parity counter and a packet counter.

10. The method of claim 8, wherein determining that an error is possible in the MPE-FEC table, comprises:
tracking a section offset contained in an MPE packet header with a section offset of the MPE-FEC table and using said section offset to designate said area of suspicion.

11. The method of claim 8, further comprising:
estimating, by a lost packet determination logic, an expected number of packets, expected to be received within a time interval, based on packet arrival speed; and
determining a number of lost packets, by said lost packet determination logic, using the expected number of packets and a packet counter, wherein the packet counter counts a plurality of received packets.

12. An apparatus comprising:
a multi-protocol encapsulation forward error correction (MFEC) logic;
a lost packet determination logic, operatively coupled to said MFEC logic, said lost packet determination logic operative to:
estimate an expected number of packets, expected to be received within a time interval, based on packet arrival speed; and
determine a number of lost packets using the expected number of packets and a packet counter wherein the packet counter counts a plurality of received packets.

13. The apparatus of claim 12, wherein said lost packet determination logic is further operative to:
compare said expected number of packets to said packet counter and determining that said expected number of packets is greater than said packet counter; and
determine a number of lost packets by said expected number of packets and said packet counter, where said number of lost packets exceeds a packet counter maximum of said packet counter.

14. The apparatus of claim 12, wherein said lost packet determination logic is further operative to:
determine the correct order of a plurality of received packets prior to providing said received packets to a decoder logic.

15. The apparatus of claim 12, wherein said lost packet determination logic is further operative to estimate an expected number of packets, expected to be received within a time interval, based on packet arrival speed, by:
estimating an expected number of transport stream packets forming an multi-protocol encapsulation forward error correction table; and
wherein determining the correct order of a plurality of received packets prior to providing said received packets to a decoder logic, comprises determining the correct order of said transport stream packets in said multi-protocol encapsulation forward error correction table.

16. A DVB receiver comprising the apparatus of claim 12.

17. The apparatus of claim 12, further comprising:
a decapsulator logic comprising said a multi-protocol encapsulation forward error correction (MFEC) logic, and operatively coupled to said lost packet determination logic, said decapsulator logic operative to:
receive a plurality of transport steam packets, said transport stream packets encapsulating at least one multi-protocol encapsulation (MPE) packet including an MPE packet header, said multi-protocol encapsulation packet further encapsulating a plurality of Internet Protocol (IP) datagrams, wherein said MPE packet is received in an MPE frame that includes forward error correction (FEC) data for said MPE packet;
an offset tracking and erasure marking logic, operatively coupled to said decapsulator logic, said offset tracking and erasure marking logic operative to:
mark all bytes of said MPE packet including said MPE packet header as erasures in response to decoding the plurality of transport stream packets and obtaining a decoding failure; and
introduce said erasures to an erasure based decoder along with a plurality of successfully decoded MPE packets.

18. The apparatus of claim 12, further comprising:
a simplified erasure-based Reed-Solomon (ERS) decoder logic including a Syndrome Calculation Unit and an Error Correlation Unit, but not including a Key Equation Solver and a Chien Search Unit, said simplified ERS decoder logic operatively coupled to said decapsulator logic;
wherein said offset tracking and erasure marking logic is further operative to:
introduce said erasures to said simplified ERS decoder logic along with a plurality of successfully decoded MPE packets.

19. A computer readable memory comprising:
executable instructions for execution by at least one processor, that when executed cause said at least one processor to:
estimate an expected number of packets, expected to be received within a time interval, based on packet arrival speed; and
determine a number of lost packets, by said lost packet determination logic, using the expected number of packets and a packet counter wherein the packet counter counts a plurality of received packets.

20. The computer readable memory of claim 19, wherein said executable instructions, when executed further cause the one or more processors to:
decode a plurality of transport stream packets and obtain a decoding failure;
mark all bytes of said MPE packet including said MPE packet header as erasures in response to obtaining said decoding failure; and
introduce said erasures to an erasure based decoder along with a plurality of successfully decoded MPE packets.
